(19) United States
(12) Patent Application Publication
(10) Pub. No.: US 2023/0376350 A1
(43) Pub. Date: Nov. 23, 2023

(54) SYSTEM AND METHOD FOR ADAPTING TO CHANGING RESOURCE LIMITATIONS

(71) Applicant: InterDigital CE Patent Holdings, SAS, Paris (FR)

(72) Inventors: Francois Schnitzler, Saint Avé (FR); Francoise Le Bolzer, RENNES (FR); Tsiry Mayet, Le Mans (FR); Anne Lambert, Saint-Aubin-d'Aubigné (FR)

(73) Assignee: InterDigital CE Patent Holdings, SAS, Paris (FR)

(21) Appl. No.: 18/044,709

(22) PCT Filed: Sep. 15, 2021
(86) PCT No.: PCT/EP2021/075272

§ 371 Date: Mar. 9, 2023

(30) Foreign Application Priority Data
Sep. 22, 2020 (EP) 20306073.6

(51) Int. Cl. G06F 9/50; G06N 3/045; G06N 3/0442

(52) U.S. Cl. CPC G06F 9/5005; G06N 3/045; G06N 3/0442

(57) ABSTRACT

An apparatus, system or method for processing a sequence of data can involve determining an availability of a computational resource; adapting, based on the availability, a neural network to set a limit on use of the computational resource by the neural network during processing of a sequence of data, wherein the one or more processors being configured to adapt the neural network to set the limit comprises the one or more processors being configured to modify an update control included in the neural network based on a windowing function; and processing at least a portion of the sequence of data by the adapted neural network using the computational resource in accordance with the limit.

### TECHNICAL FIELD

The present disclosure involves artificial intelligence systems, devices and methods.

### BACKGROUND

Systems such as a home network can contain, implement or provide dedicated resources to manage services in the home in connection with, or at the request of, heterogeneous consumer electronics (CE) devices in the home. For example, such systems can include or involve artificial intelligence (AI) resources such as AI systems, devices and methods that can be used to control CE devices, e.g., by learning and adapting to any of a plurality of variables such as the environment in which devices are located, user(s) of the device, etc. An aspect of AI resources in an environment such as home networks and systems can include an “AI hub”. An example of an embodiment of an AI hub can be a “boosted” or enhanced AI consumer premises equipment (CPE) device such as a set-top box (STB), gateway device, edge computing resource, etc. As an example, an AI hub can be a central node within the system that can, for example: a) provide virtualization environment to host AI micro services, b) ensure interoperability with connected CE devices or edge computing, c) provide access to services and resources (compute, storage, video processing, AI/ML, accelerator), and/or d) offload computational AI tasks to other CE devices registered in a “home data center”.

### SUMMARY

In general, an example of at least one embodiment can involve a neural network such as a recurrent neural network (RNN) having a capability to vary its computational cost while strictly limiting the computational resources used by the RNN.

In general, an example of at least one embodiment can involve apparatus and methods for an orchestrator/scheduler to control the computational cost of a neural network model with an upper limit clearly set out.

In general, an example of at least one embodiment can involve apparatus comprising: one or more processors configured to determine an availability of a computational resource; adapt, based on the availability, a neural network to set a limit on use of the computational resource by the neural network during processing of a sequence of data, wherein the one or more processors being configured to adapt the neural network to set the limit comprises the one or more processors being configured to modify an update control included in the neural network based on a windowing function; and process at least a portion of the sequence of data by the adapted neural network using the computational resource in accordance with the limit.

In general, an example of at least one embodiment can involve method comprising: determining an availability of a computational resource; adapting, based on the availability, a neural network to set a limit on use of the computational resource by the neural network during processing of a sequence of data, wherein adapting the neural network to set the limit comprises modifying an update control included in the neural network based on a windowing function; and processing at least a portion of the sequence of data by the adapted neural network using the computational resource in accordance with the limit.

In general, an example of at least one embodiment can involve apparatus comprising: one or more processors configured to adapt, based on an availability of a computational resource, a neural network to set a limit on use of the computational resource during processing of a sequence of data, wherein the one or more processors being configured to adapt the neural network to set the limit comprises the one or more processors being configured to modify, based on a windowing function, an update control included in the neural network; and process at least a portion of the sequence of data by the adapted neural network using the computational resource in accordance with the limit.

In general, an example of at least one embodiment can involve a method comprising: adapting, based on an availability of a computational resource, a neural network to set a limit on use of the computational resource during processing of a sequence of data, wherein adapting the neural network to set the limit comprises modifying, based on a windowing function, an update control included in the neural network; and processing at least a portion of the sequence of data by the adapted neural network using the computational resource in accordance with the limit.

In general, an example of at least one embodiment can involve apparatus comprising: one or more processors configured to implement a neural network including an update control; determine an availability of a computational resource; adapt the neural network, based on the availability, to set a limit on use of the computational resource by the neural network during processing of a sequence of data, wherein the one or more processors being configured to adapt the neural network to set the limit comprises the one or more processors being configured to modify the update control included in the neural network based on a windowing function; and process at least a portion of the sequence of data by the adapted neural network using the computational resource in accordance with the limit.

In general, an example of at least one embodiment can involve apparatus comprising: one or more processors configured to receive an indication of an availability of a computational resource; adapt, based on the indication, a neural network to set a limit on use of the computational resource during processing of a sequence of data, wherein the one or more processors being configured to adapt the neural network to set the limit comprises the one or more processors being configured to modify, based on a windowing function, an update control included in the neural network; and process at least a portion of the sequence of data by the adapted neural network using the computational resource in accordance with the limit.

In general, an example of at least one embodiment can involve a method comprising: receiving an indication of an availability of a computational resource; adapting, based on the indication, a neural network to set a limit on use of the computational resource during processing of a sequence of data, wherein adapting the neural network to set the limit comprises modifying, based on a windowing function, an update control included in the neural network; and processing at least a first portion of the sequence of data by the adapted neural network using the computational resource in accordance with the limit.

In general, an example of at least one embodiment can involve apparatus comprising: one or more processors configured to determine an availability of a computational resource; and enable, based on the availability, a modification of a neural network to set a limit on use of the computational resource by the neural network during processing of a sequence of data, wherein the modification comprises modifying, based on a windowing function, an update control included in the neural network.

In general, an example of at least one embodiment can involve a method comprising: determining an availability of a computational resource; and enabling, based on the availability, a modification of a neural network to set a limit on use of the computational resource by the neural network during processing of a sequence of data, wherein the modification comprises modifying, based on a windowing function, an update control included in the neural network.

The above presents a simplified summary of the subject matter in order to provide a basic understanding of some aspects of the present disclosure. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description provided below.

### BRIEF DESCRIPTION OF THE DRAWINGS

The present disclosure may be better understood by considering the detailed description below in conjunction with the accompanying figures, in which:

FIG. 1 provides a graph illustrating data processing in accordance with one or more aspects of the examples of systems and methods described herein;

FIG. 2 provides another graph illustrating data processing in accordance with one or more aspects of the examples of systems and methods described herein;

FIG. 3 illustrates, in block diagram form, an example of an embodiment in accordance with one or more aspects of the present disclosure;

FIG. 4 illustrates, in block diagram form, an example of an embodiment of a portion of the embodiment of FIG. 3;

FIG. 5 illustrates an example of one or more features in accordance with the present disclosure;

FIG. 6 provides a graph illustrating data processing in accordance with one or more aspects of the examples of systems and methods described herein;

FIG. 7 provides a graph illustrating data processing in accordance with one or more aspects of the examples of systems and methods described herein;

FIG. 8 illustrates an example of an embodiment in accordance with at least one aspect of the present disclosure;

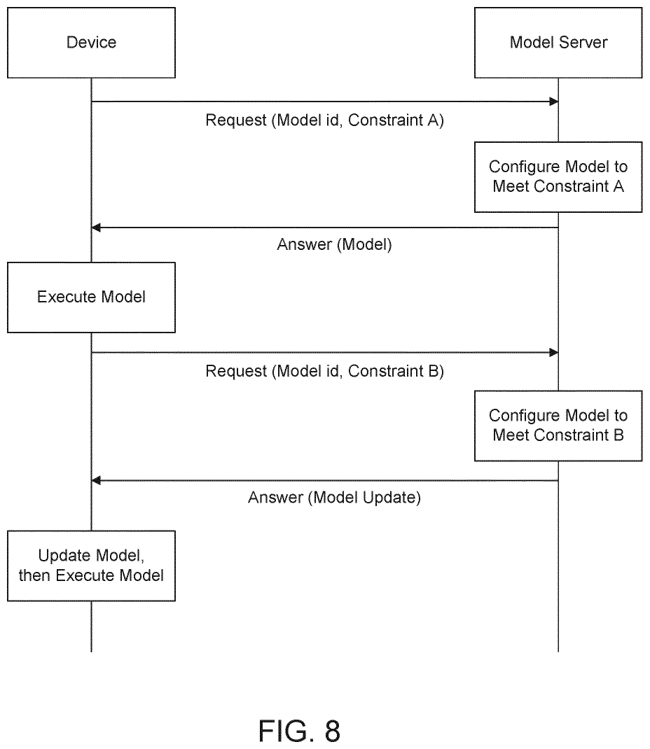

FIG. 9 provides a flow diagram illustrating an example of an embodiment of a method in accordance with one or more aspects of the present disclosure; and

FIG. 10 illustrates, in block diagram form, an example of an embodiment of a system suitable for implementing one or more aspects of the present disclosure.

It should be understood that the drawings are for purposes of illustrating examples of various aspects, features and embodiments in accordance with the present disclosure and are not necessarily the only possible configurations. Throughout the various figures, like reference designators refer to the same or similar features.

### DETAILED DESCRIPTION

One aspect of AI hub functionality involves allocating computational resources to various AI services. At some point, the demand may exceed the available resources and a control system, or processor, or software, generally referred to herein as an “orchestrator”, will operate to limit resources available to some or all services. An orchestrator/scheduler can provide for controlling where and when AI models, for example machine learning models, are executed. For example, an orchestrator/scheduler may provide at least one or more of the following functionalities:
allocate computational resources to deep models
decide on which hardware the model is run
monitor resource availability
monitor the execution of a process (including a ML model)
selects the model to be run, including adapting it to constraints such as resource requirements and/or resource availability (e.g., computational resource availability or requirements) and/or accuracy requirements.

An aspect of the present disclosure involves providing systems and methods that avoid severe disruption or shutdown by enabling adaptation to constraints. In general, at least one example of an embodiment described herein involves a flexible AI system that can receive an instruction or instructions from an orchestrator or a scheduler running a control feature or device such as an AI hub and adapt its configuration or architecture or model in accordance with the instruction. For example, an instruction might be based on constraints such as current resource requirements or availability or accuracy and instruct the neural network to change one or more characteristics or parameters to adapt to the current constraints. If the constraint or constraints change then one or more additional instructions can be provided to further adapt the neural network to the changed constraint.

The use of an orchestrator and flexible AI systems to maintain a reasonable quality of service may also be implemented on a single device running multiple AI processes. For example, a device such as a smartphone can contain dedicated hardware to accelerate AI processes and enabling such devices to run or provide the functionality of an orchestrator. Other possible devices include smart cars, computers, home assistants or other devices capable of communication via a network such as a home network, e.g., Internet of things, or IoT devices.

In addition, edge computing may involve AI processes and associated resource constraints, e.g., where cloud services are run on edge computing nodes close to the user. As an example, when processes are moved to a new edge node, constraints such as resource availability, e.g., computational resource availability, might be different.

An example of an AI system in accordance with one or more aspects of the present disclosure is a deep neural network (DNN). A DNN is a complex function or system, typically composed of several neural layers (typically in series) and each neural layer is composed of several perceptrons. A perceptron is a function involving a linear combination of the inputs and a non-linear function, for example a sigmoid function. Trained by a machine learning algorithm on huge data sets, these models have recently proven extremely useful for a wide range of applications and have led to significant improvements to the state-of-the-art in artificial intelligence, computer vision, audio processing and several other domains.

Recursive neural networks (RNN) denote a class of deep learning architectures specifically designed to process sequences such as sound, videos, text or sensor data. RNNs are widely used for such data. Frequently used neural architectures include long short-term memory (LSTM) networks and gated recurrent units (GRU). Typically, RNN maintain a “state”, a vector of variables, over time. This state accumulates relevant information and is updated recursively. At a high-level, this is like hidden Markov models. Each input of the sequence is typically a) processed by some deep layers and b) then combined with the previous state through some other deep layers to compute the new state. Hence, the RNN can be seen as a function taking a sequence of inputs x=(x₁, . . . , x_{T}) and recursively computing a set of states s=(s₁, . . . , s_{T}). Each state sₜ is computed from sₜ₋₁ and xₜ by a cell S of the RNN.

Fully processing the input to an RNN, or other DNN, can be resource intensive. An approach to controlling or modifying resource requirement of a RNN can involve an architecture that can be controlled by an orchestrator to adapt the RNN computation to changing computational resources. For example, the RNN architecture can be based on approaches that implement conditional computation. Such approaches reduce the computational load of RNNs by skipping some inputs and/or by updating only a part of the state vector. An example of such approaches skipping some inputs is the skip-RNN architecture. A controllable RNN based on skip-RNN skips inputs based on a state update control (e.g., gate) uₜ. An example of an embodiment of a state update control is defined by (equation 1) and subsequent equations.

$${u}_{t} = {f}_{binarize} ( {\tilde{u}}_{t} , thr ) = \{ \begin{matrix}0 if {\tilde{u}}_{t} < thr \\ 1 otherwise\end{matrix} . \qquad ( 1 )$$

$$Δ {\tilde{u}}_{t} = σ ( W {s}_{t} + b )$$

$${\tilde{u}}_{t + 1} = {u}_{t} Δ {\tilde{u}}_{t} + ( 1 - {u}_{t} ) ( {\tilde{u}}_{t} + min ( Δ {\tilde{u}}_{t} , 1 - {\tilde{u}}_{t} ) ) .$$

$${s}_{t} = {u}_{t} S ( {s}_{t - 1} , {x}_{t} ) + ( 1 - {u}_{t} ) {s}_{t - 1} \qquad ( 2 )$$

In the example of equations (1) and (2), ƒ_{binarize} denotes a binarization function (in other words, the output is 0 if the input is smaller than 0.5 and 1 otherwise), σ a non-linear function and W and b the trainable parameters of the linear part of the state update gate (a perceptron) ƒ_{binarize} can also be a stochastic sampling from a Bernoulli distribution whose parameter is the input ũₜ. The thr parameter allows to adjust dynamically the tradeoff between the accuracy and the number of updates during inference. A state update control as in the example of equation (2) determines whether an input is skipped or not.

A model such as the RNN example described above is trained on a dataset containing a set of input sequences and label(s) associated to each sequence. The model is trained to minimize a loss computed on this labeled data. The loss is the sum of two terms: one term related to the accuracy of the task (for example cross-entropy for classification or Euclidian loss for regression), and a second term that penalizes computational operations: L_{budget}=λΣₜ uₜ, where λ is a weight controlling the strength of the penalty and uₜ, as defined above, is 0 if there is no update to the state and 1 if there is.

There are other approaches similar to skipRNN that propose an alternative mechanism to reduce computation dynamically based on inputs, for example by also skipping some or only updating part of the state vector. These mechanisms include a decision function, similar to the equations described above. Examples of other approaches include Jump-LSTM, Skim-RNN, VCRNN, and G-LSTM.

Skip-RNN and other related approaches aim to reduce computation while maintaining accuracy. While they allow the system to run using fewer computational resources, the system is fixed and cannot adapt to changing computational constraints. Furthermore, these approaches do not provide for communication with an orchestrator/scheduler.

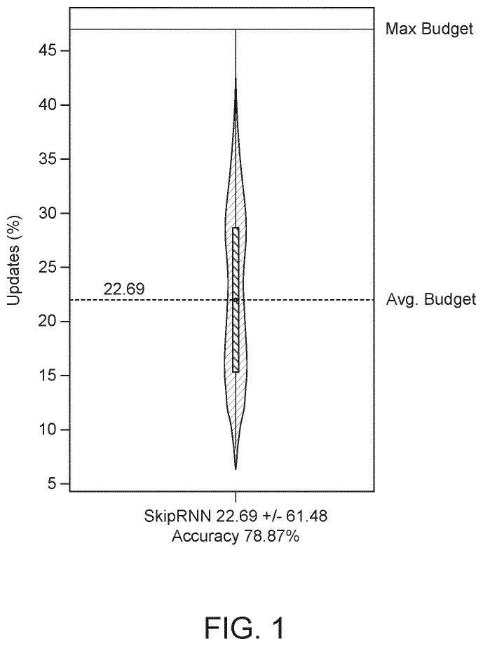

An approach such as that described above involving conditional computation enables adapting the computational cost to changing computational resources on an average basis. Consider the example of FIG. 1 which illustrates an update rate distribution obtained with skip-RNN. Each value in the empirical distribution corresponds to the fraction of updates performed for a single sequence of inputs. The example of FIG. 1 shows a distribution for a skip-RNN model that has been configured to provide an average accuracy/updates tradeoff equal to 78.87%/22.69%. The ‘updates’ term represents the computational cost expressed as the rate of inputs processed by the RNN. In FIG. 1, it can be observed that the updates rate distribution is spread around the average value of 22.69%. That means, the update rate (or computational cost) varies significantly between sequences (from 6% to 46%).

Therefore, AI systems such as RNNs running on shared hardware might be shut down when other processes require the use of the resources and when the remaining resources available for the RNN is close to its average budget. In that case, the RNN might require at certain times a computation budget higher than the allocated average budget, thereby preventing the RNN from working well. This might for example lead to longer than expected time to process a sequence and, therefore, could cause one or more undesirable effects such as delaying a time-critical output.

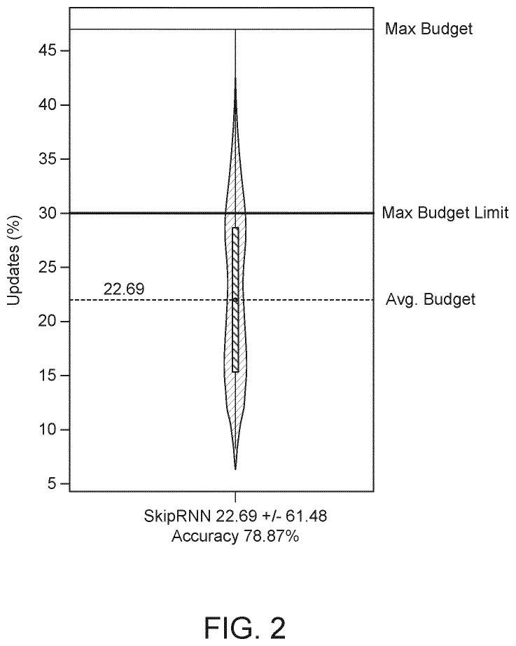

Currently, for an AI system such as one based on a Recurrent Neural Network (RNN) architecture, there is no approach to control the system, e.g., by an orchestrator or other control, to enforce a constraint such as a limit on availability of computational resources. For example, there is no RNN architecture that can strictly limit its computations according to changing computational resources. Therefore, RNNs running on shared hardware might be shut down if the resources available on the computation platform is less than required resources of an RNN. An example is illustrated in FIG. 2 where the maximum available resources, designated “Max Budget Limit” in FIG. 2, is lower than the required resources of a RNN, designated “Max Budget” in FIG. 2, thereby possibly causing effects such as time critical responses being delayed.

In general, an example of an embodiment providing for limiting, e.g., strictly limiting, computational resource availability provided to an AI system will now be described. Stated differently, the example embodiment to be described involves, for example, strictly limiting a computational cost associated with the AI system.

In general, another example of an embodiment will be described involving enabling a control device, system or method such as an orchestrator or scheduler to use, apply or leverage a capacity to limit computational cost of an AI system.

An example of an embodiment of limiting, e.g., strictly limiting, computational cost of an AI system will be based on a RNN model or architecture and, in at least one example of an embodiment, will be based on a skip-RNN model implementing a conditional computation that skips inputs based on a state update gate uₜ defined by (1) and subsequent equations. One or more aspects, features or embodiments described herein can also be used with other conditional computation architectures for RNNs.

In at least one example of an embodiment, a conditional computation feature or mechanism, e.g., a skip mechanism, will be modified, including the update gate uₜ, to limit (e.g., strictly limit) the computational cost of a flexible RNN. The described example of a RNN architecture will be referred to herein as skip-Window or Sw. Such reference is merely for ease of explanation and is not intended to limit, and does not limit, the scope of application or implementation of aspects or principles described herein.

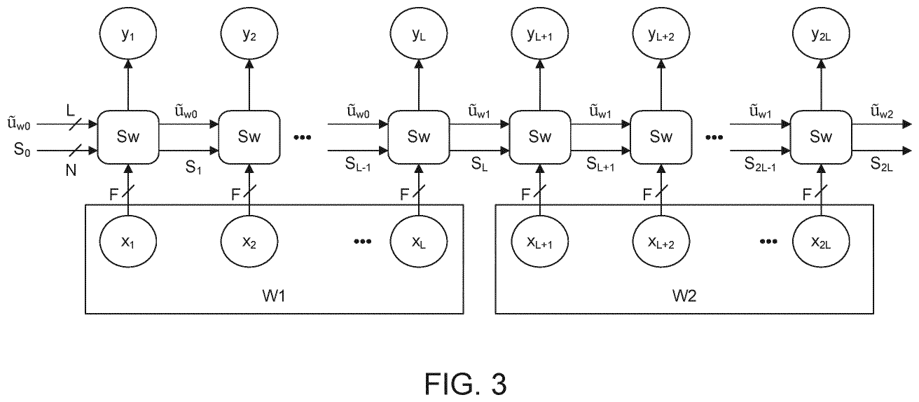

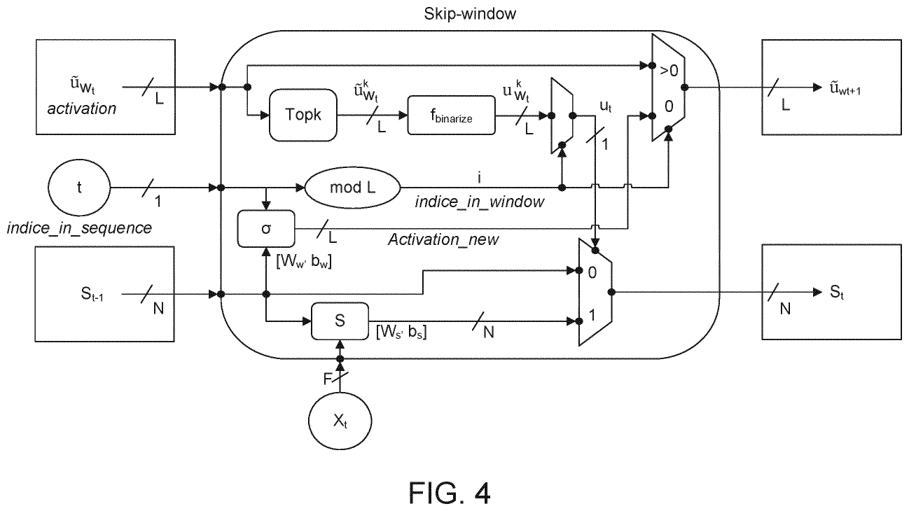

An example of an embodiment of an aspect of the described skip-Window AI system, device or method is illustrated in FIG. 3. In FIG. 3, the update control or function, e.g., an update gate, is windowed, i.e., it is no longer computed at each time step t of the sequence. It is computed every L time steps, i.e., after the RNN cell processed an L-size window of inputs as shown in FIG. 3, thereby providing sequence windowing for the skip-Window processing. Also in the example embodiment of FIG. 3, the windowed update control computes before any new L-size window of inputs, an L-size vector ũ_{W} defining the probability of each input in the coming window to be processed. In addition, the example embodiment of FIG. 3 includes a “selectK” function or mechanism. This function takes as input the vector ũ_{W} and outputs the vector ũ_{W}^{K}. This function sets L-K bits to a value (e.g., 0 in FIG. 4) that ensures the associated inputs are not processed. Therefore, an embodiment such as that illustrated in FIG. 3 ensures that at most K out of every L inputs will be processed or in other words that the RNN cell is caused or forced to skip (L-K) out of every L inputs. This ensures a strict upper bound on the computational cost of the model. Also with regard to the example embodiment of FIG. 4, the binary state update L-size vector, u_{W}, is then obtained based on an update control function, e.g., by binarizing the remaining values as in equation (1) above. For example, by setting all values below a threshold to a value that ensures the associated inputs are not processed (0 in FIG. 4).

Variants of the binarization are possible. For example, one variant can involve reducing the processing for an input to a portion of percentage of full value, e.g., 25%, 50%, 75% rather than a binary choice of using it or not (100% or 0%). This could be implemented, for example, by updating only some of the hidden states, using only a fraction of the weights, using different cells etc. Also, this last step of modifying an update control function is optional. That is, for example, at least one example of an embodiment could involve implementing that u_{W}=ũ_{W}^{K}.

An example of an embodiment of the Skip-window cell (Sw blocks or cells in FIG. 3) is illustrated in FIG. 4. In the example of FIG. 4, selectK is a top K function. The top K operation keeps unchanged the K highest values in ũ_{Wt}, and resets to 0 the (L-K) others. This enforces the strict constraint on the number of updates. The corresponding architecture can be characterized as follows:

$${s}_{t} = {u}_{t} \cdot S ( {s}_{t - 1} , {x}_{t} ) + ( 1 - {u}_{t} ) \cdot {s}_{t - 1} \qquad ( 3 )$$

$${\tilde{u}}_{{W}_{t}} = γ \cdot σ ( {W}_{W} ( {s}_{t - 1} , t ) + {b}_{W} ) + ( 1 - γ ) \cdot {\tilde{u}}_{{W}_{t}} \qquad ( 4 )$$

$$γ = \{ \begin{matrix}0 & if i = 0 \\ 1 & otherwise\end{matrix} \qquad ( 5 )$$

$$i = t mod L \qquad ( 6 )$$

$${\tilde{u}}_{{W}_{t}}^{k} = Top K ( {\tilde{u}}_{{W}_{t}} ) \qquad ( 7 )$$

$${u}_{t} = {f}_{binarize} ( {\tilde{u}}_{{W}_{t}}^{k} ( i ) , thr ) = \{ \begin{matrix}0 & if {\tilde{u}}_{{W}_{t}}^{k} ( i ) < thr \\ 1 & otherwise\end{matrix} \qquad ( 8 )$$

where W_{W} is a weight matrix of size (N+1)×L, N is the number of hidden states as defined by the RNN cell S, b_{W} is a L-vector bias, a is the sigmoid function and mod is the modulo operation.

At least several variants of the example embodiments illustrated in FIGS. 3 and 4 are possible. For example, a constraint, such as a strict constraint, on the number of updates can be achieved in different ways. There are various possible alternatives to using a topK function as selectK. For example, selectK could be:
a stochastic sampling mechanism or function that randomly selects (without replacement) K out of L elements of ũ_{W} where the probability of selecting each element of index i is proportional to ũ_{W}[i]. These K elements are then either left untouched or set to a value that ensures they will be processed and the other L-K elements of ũ_{W} are set to a value that ensures the associated inputs are not processed (0 in Error! Reference source not found.); or
a function that keeps the first K elements of ũ_{W} above a threshold unchanged (or set them to a value that ensure they are processed) and sets the other L-K elements to a value that ensures they will not be processed; or
a function that randomly samples K elements out of the elements of ũ_{W} that are above a threshold, keeps these elements unchanged (or sets them to 1) and sets the other L-K elements to a value that ensures they will not be processed.
a function that, out of the elements of ũ_{W} that are above a threshold, selects K elements sₖ* that are as far away as each other as possible within the vector, e.g., by measuring the distance between the indexes of a set sₖ as d(sₖ)=Σ_{{i,j}∈s}_{ₖ}_{,i≠j}(i−j)²) and selecting sₖ*=argmax d(sₖ).
a function that provides a selection of inputs and an input processing operation for each selected input based on the cost of each processing operation

Similarly, alternatives are possible for ƒ_{binarize}. For example, ƒ_{binarize} is optional so it could be the identify function. As another example, ƒ_{binarize} could be a stochastic function, e.g., the output could be one random sample from a Bernouilli distribution whose probability of success is the input.

There are also alternatives to equation (4). Examples include the following. In a variant, the potentially updated value for ũ_{W}_{ₜ}, σ(W_{W}(sₜ₋₁,t)+b_{W}), can be computed differently. Rather than a sigmoid, the activation function could be different, for example a Hyperbolic Tangent, a Rectified Linear Unit (ReLU) or a Leaky Rectified Linear Unit. In another variant, rather than a fully connected, one-layer neural network, the σ(W_{W}(sₜ₋₁, t)+b_{W}) could have more than one layer and/or not be fully connected and/or depend on some or all inputs of the sequence and/or depends on some or all previous states of the RNN, possibly through an attention mechanism or some other averaging scheme. Another example of an alternative to equation (4) is that σ(W_{W}(sₜ₋₁, t)+b_{W}) could be another trained machine learning model, such as a decision tree or a linear regression. It could also be defined by an expert rather than trained.

Including the time step “t” in equation (4) is also optional. It could also be replaced by a different value that ensures the state is not static if no update is made in a window. For example, the time step could be replaced by the number of inputs since the last update or the number of windows already computed.

In a variant, the update of ũ_{W}_{ₜ} can be performed at a different interval. For example, equation (5) could be modified so that γ is computed by a neural network, a different machine learning model or function defined by an expert. This could also be limited to all or some of the time steps where i is not equal to 0.

Also, S can be based on any form of RNN cell, for example a LSTM or GRU cell.

More generally, for other conditional computation RNN architectures, the selectK mechanism must ensure that computation within a window does not exceed the limit. Given a vector u_{W}_{ₜ} of length L where each element u_{W}_{ₜ}[i] controls the computational cost of one input within the window, the cost of processing the window is Σ_{i∈[1,L]}c(u_{W}_{ₜ}[i]) where c(u_{W}_{ₜ}[i]) denotes the cost of the processing one input for the value u_{W}_{ₜ}[i] in u_{W}_{ₜ}. So for a maximum computational cost C, selectK must implement a selection strategy that enforces that Σ_{i∈[1,L]}c(u_{W}_{ₜ}[i])<C.

The described skip window architecture can be trained like the skip-RNN model. That is, the described architecture can be trained on a dataset containing a set of input sequences and label(s) associated to each sequence. The model is trained to minimize a loss computed on this labeled data. The loss is the sum of two terms: one term related to the accuracy of the task (for example cross-entropy for classification or Euclidian loss for regression), and a second term that penalizes computational operations: L_{budget}=λΣₜuₜ, where λ is a weight controlling the strength of the penalty and uₜ, as defined above, is 0 if there is no update to the state and 1 if there is. The model can be trained on minibatches of data using GPUs and stochastic gradient descent. The model can be trained with a fixed (thr, K) and used as is. Some implementations of selectK may not be differentiable, which is problematic for training the model. In that case, it is possible to replace selectK by an approximate function that is differentiable, a common practice when training deep learning models. For example, topK is not differentiable. For training, we replaced topK by the identity function, which is equivalent to using K=L. The model could also be trained by varying both parameters during training, either to fixed but different values for each minibatch or to different values for different points in the sequence.

For embodiments such as the examples described herein that depend on (thr, K), during inference the pair (thr, K) can be modified dynamically. An example of an embodiment to implement this is to augment the input of the model. In addition to the inputs x=(x₁, . . . , x_{T}), the model can receive two sequences of parameters thr=(thr₁, . . . , thr_{T}) and k=(k₁, . . . , k_{T}). These parameters can then be fed, for example, to the TopK and ƒ_{binarize} operations. As an example of an alternative, one or both parameters can be static and changed in memory when necessary.

As a side note, inference must be performed with a different implementation than for training. When using a deep learning framework such as TensorFlow or Pytorch, and depending on the framework used, the training implementation will typically not achieve any computational gain as both the skip and the non-skip operation are computed at every time step. For inference, the condition must be evaluated before computing unnecessary values. This can for example be achieved using eager execution or by using conditional operators such as tf.cond.

One or more of the example embodiments described above illustrate an update control feature involving either processing or not processing an input, e.g., an update gate for which the only possible results are either to process the input or not. Alternatives mechanisms could be used. As a first example, only part of the hidden state could be updated. In that case, the selectK would be a function that would select for each input in the window an integer nₜ∈{0, . . . , N} such that the number of computation in the window is lower than the maximum computation B allowed for that window. For example such a function may assign to each input the highest value nₜ such that the computational cost of updating nₜ hidden state is lower than

$$\frac{{\tilde{u}}_{{W}_{t}} ( t mod L )}{{\sum }_{i = 0}^{L - 1} {\tilde{u}}_{{W}_{t}} ( i )} B ,$$

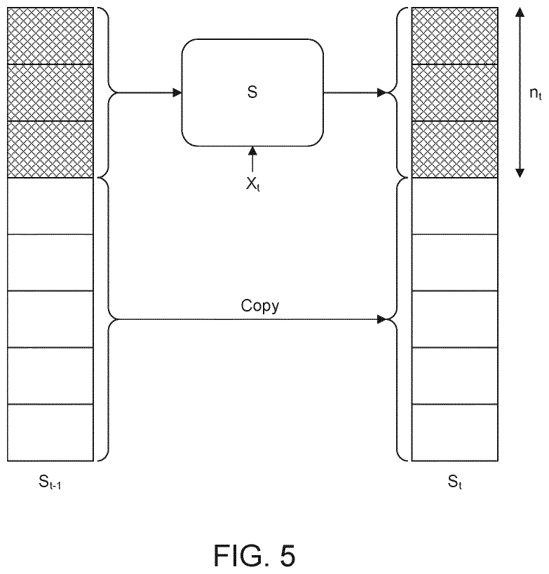

that is, the fraction of the budget proportional to its weight ũ_{W}_{ₜ}(t mod L), that could be interpreted as its importance. nₜ then represents the number of dimensions of the hidden state to update. The described example is illustrated in FIG. 5.

As a second example, different cells Sⱼ,j∈{1, . . . , J} could be available, each with a different computational cost, for example because some contains more parameters than others or because these parameters are encoded using more bits. In that case, the selectK function would select for each input a cell Sⱼ, for example the one with the highest computational cost that is lower than

$$\frac{{\tilde{u}}_{{W}_{t}} ( t mod L )}{{\sum }_{i = 0}^{L - 1} {\tilde{u}}_{{W}_{t}} ( i )} B .$$

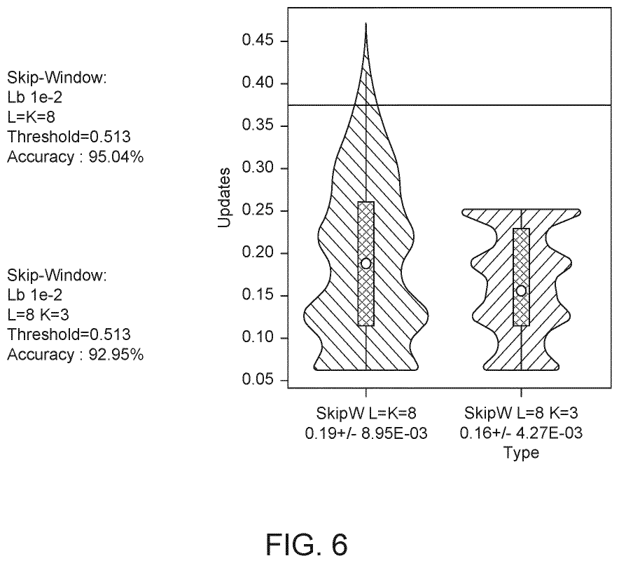

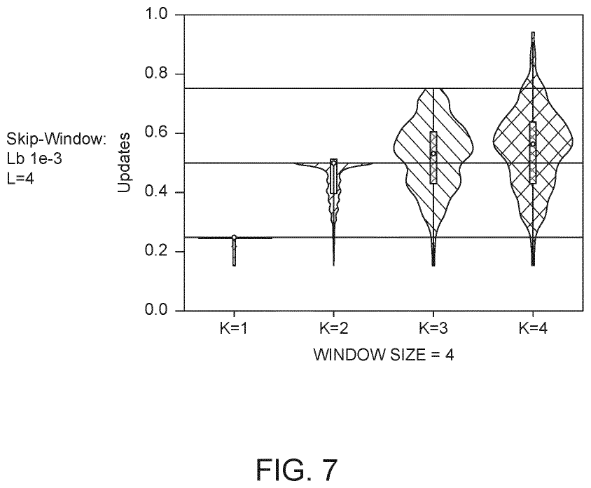

As an example of the operation of an AI system involving the described skip-Window arrangement, an RNN system based on an example embodiment such as that illustrated in FIGS. 3 and 4 was used to process data associated with a benchmark problem designated “HAR”. In this problem, the RNN takes as input a sequence of 32 2D-skeletons. Each skeleton is defined by 36 coordinates corresponding to the 18 body joints in 2 dimensions. The task of the network is to classify among 6 actions each sequence of 2D-Poses. For this problem, FIG. 6 shows a comparison between processing by the RNN based on skipW where the diagram or plot on the right side of FIG. 6 illustrates the operation for skipW having parameters λ=1e−2, L=8, thr=0.513, K=3 and the plot left side illustrates operation for skipW having parameters λ=1e−2, L=8, thr=0.513, K=L. It is clear from the example of FIG. 6 that for the same value of thr the system where K<L meets (i.e., does not exceed or is less than) the computational constraint illustrated by the horizontal line at updates=0.375. FIG. 7 illustrates the impact of the K parameter on the upper limit of computational cost. In FIG. 7, for a skip-Window embodiment having a window size of 4 (L=4), the value of K varies from 1 to 4. Each value of K produces a respective different computational cost upper limit as shown by a different horizontal line corresponding to each value of K.

The described systems, apparatus and methods can be applied to various applications involving AI models analyzing a stream of data on constrained hardware, such as systems for processing sensor readings, or audio or video directly on a user device such as a camera, smartphone or set-top box.

In general, at least one example of an embodiment can involve a system, apparatus or method based on enabling an orchestrator to control the cost of a model or AI system such as those described. The AI system can include an orchestrator or scheduler capability or communicate with a separate system or device providing the capability or functionality of an orchestrator or scheduler. For example, the architecture described above has a computational cost that can be tuned by varying (thr, k) and various system, apparatus and methods will now be described that enable or allow an orchestrator/scheduler to control the described architecture.

In general, at least one example of an embodiment can involve an orchestrator determining an availability of a computational resource. Then, the orchestrator can enable modification of a neural network, e.g., a RNN with skip-Window architecture as described herein, based on the availability. As an example, an orchestrator can provide or send an indication, e.g., a signal or control signal, to a neural network that indicates an availability of a computational resource. This signal or indication can be received by a neural network to enable a modification of the neural network such as, for example, modifying an update control of the neural network, e.g., modification based on a windowing function as described herein, to set a limit on use of the computational resource by the neural network during processing of a sequence of data.

At least one example of an embodiment can involve the model having in its metadata and/or exposing through other means to the orchestrator/scheduler information about the expected behavior of the model. This information could for example be a table containing triplets of ((thr, k), expected computational cost, maximum computational cost). Computational costs can for example be expressed in FLOPS. The expected cost could denote the expected cost per element of the input vector or for sequences of different lengths. The maximum cost could denote the maximum computational cost the model will use. The table may also contain the expected accuracy associated to each (thr, k) values. The orchestrator can then use this information to drive the behavior of the model by selecting the appropriate (thr, k) and sending it to the model.

Various variants can involve the described information being encoded differently or in various ways. For example, the information could be encoded by a function accepting as input any (thr, k) values and returning the expected and maximum computational costs, or a function accepting as input a maximum computational cost and returning the ((thr, k), expected computational cost) values expected to achieve that cost.

In a variant, this information could have fewer or additional data. For example, this information could be a pair (k, maximum computational cost). In that example thr would not be modified during inference. Another example would be to provide the length L of the window, a computational cost C (for example in FLOPS) for K=L (or a variant) and a set of possible values for k. This can be used to infer the maximum computational cost for each value of k by the following formula: C*K/L.

The configuration of the model (and therefore what is communicated by the orchestrator to the model to configure it) could be expressed differently than by a set of values of parameters. For example, it could be an index. In that case, this information could for example be a table containing triplets of (index, expected computational cost, maximum computational cost). Other examples described above can be similarly modified. Rather than an index, the configuration could be described by a string, a number, an element of an enumeration or any other method used to uniquely identify one out of a set of elements (here, a configuration).

In any one of or all of these examples, the information provided can also include the expected accuracy of the model for each configuration. In any one of or all of these examples, the information provided can also include the time interval or the number of inputs over which the computational cost constraint will be satisfied. The smallest value for this number of inputs is L, the time interval can be derived from L and the frequency of the inputs.

In a variant, rather than a list of pairs or triplets, the information could be encoded in a different structure, for example by a table, a hash function or other associative arrays.

In any one of or all of these examples of embodiments, the orchestrator can monitor the model to check that the actual computational cost matches the information provided and may adjust its requests to take a potential bias into account. A model can also monitor itself (e.g., through the number of skip operations) and adjust/recompute the information provided to the scheduler.

In a variant, the information/function relating (thr, k) to the accuracy, the expected and maximum computational costs can be a machine learning model.

In a variant, the same information as above can be stored within the model, either within or outside the computational graph of the deep model. The orchestrator/scheduler can then give the model a target maximum computational cost and/or expected computational cost and/or minimum accuracy value. The model can then use the table or function to translate this target computational cost into a (thr, k) value or (thr, k, L) value.

As in one or more variants described above, the model may monitor itself to adapt the information to its current working conditions and data.

At least one embodiment can use one or more of a variety of different command mechanisms between the orchestrator/scheduler and the model. For example, an embodiment could allow the orchestrator/scheduler to order the model to increase or decrease the computational resources it uses by a set amount. The orchestrator/scheduler could also tell the model to increase/decrease said resources by a factor (2; 0.5, 0.8 . . . ).

In at least one example of an embodiment, the requests of the orchestrator/scheduler (for example (thr, k) values) may be provided as input to the model (for example as an additional element in the vector x=(x₁, . . . , x_{T})). The orchestrator/scheduler may also communicate with the model through other appropriate mechanisms.

In the description above, examples and variants of embodiments involving a model and its characteristics are described for ease of explanation in the context of a single file or entity. However, at least one example of an embodiment can involve an arrangement or configuration wherein the model is not a single file that the device running the model can access. For example, a first process monitoring the constraint and responsible for adapting and/or running the model may interact with a second process that is responsible to provide a model meeting the constraint. These processes could run in different devices. An example of such a system and the associated communication scheme is illustrated in FIG. 6 that shows an example of communication between one process on a device running a model and monitoring one or more constraints and another process in a model server that can provide model adaptation to meet the one or more constraints. In FIG. 6, the first process runs on a “Device” and wants to start running a model, identified by an ID. It measures the initial constraint, and contacts a model server to request that model under constraint A, for example expressed in FLOPS. The model server configures the model to satisfy A and sends an answer with the model. The first process runs the model and monitor constraint. At some point this process decides that the model must be adapted to new constraints, B. It requests a model update from the model server. The second process on the model server configures the model to meet B. It then sends an update to the process on the device. This update could be the whole model, or a set of parameters to change, for example new values for (thr, k). The process on the device then updates the model running.

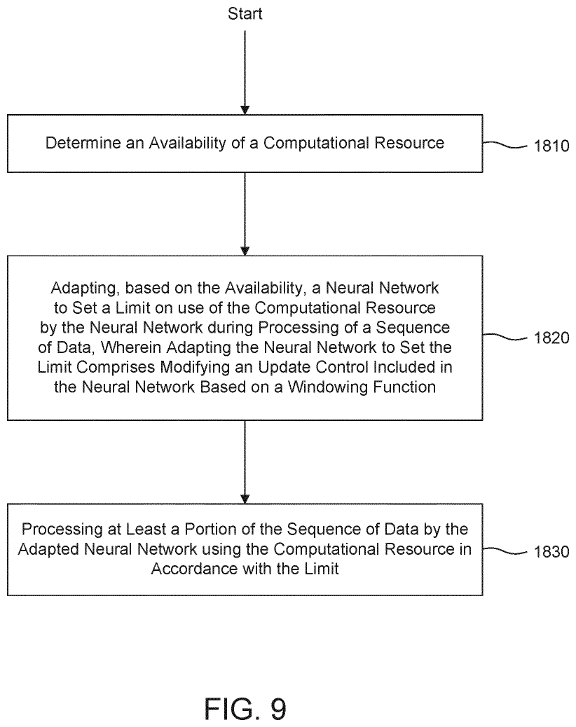

FIG. 9 illustrates another example of an embodiment comprising a method in accordance with the present disclosure. In FIG. 9, a system, e.g., one of the examples of embodiments of a neural network as described herein such as the example illustrated in FIGS. 3 and 4, can include processing capability (e.g., one or more processors) that determines at 1810 in FIG. 9 an availability of a computational resource. For example, the system can receive an indication of a resource availability such as a resource limitation or a resource requirement. For example, an orchestrator might communicate a computational resource limitation or availability of a computational resource by providing parameters for the system associated with or implementing such a limitation. As an example, the indication can be a value of a parameter or parameters such as (thr, k) that corresponds to implementing or establishing a computational resource limitation. At 1820 a neural network is adapted based on the indication to set a limit on use of the computational resource during processing of a sequence of data. Adapting the neural network to set the limit can involve modifying an update control included in the neural network based on a windowing function, e.g., an update control based on a windowing function that can include selecting a certain number of inputs for processing, e.g., a selectK feature. At 1830, the system enables processing of at least a first portion of the sequence of data by the adapted neural network using the computational resource in accordance with the limit.

This document describes various examples of embodiments, features, models, approaches, etc. Many such examples are described with specificity and, at least to show the individual characteristics, are often described in a manner that may appear limiting. However, this is for purposes of clarity in description, and does not limit the application or scope. Indeed, the various examples of embodiments, features, etc., described herein can be combined and interchanged in various ways to provide further examples of embodiments.

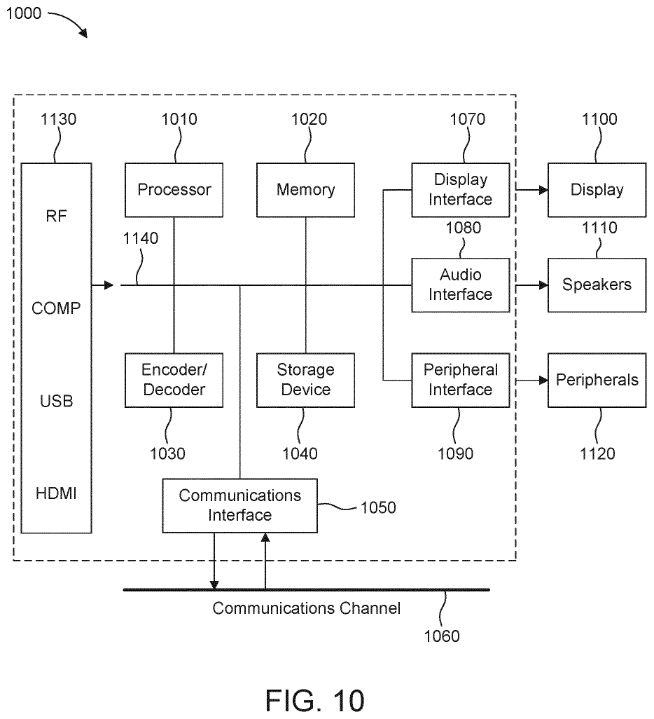

In general, the examples of embodiments described and contemplated in this document can be implemented in many different forms. For example, FIG. 10 described below provides an embodiment, but other embodiments are contemplated and the discussion of FIG. 10 does not limit the breadth of the implementations. At least one embodiment generally provides an example related to artificial intelligence systems. This and other embodiments can be implemented as a method, an apparatus, a system, a computer readable storage medium or non-transitory computer readable storage medium having stored thereon instructions for implementing one or more of the examples of methods described herein.

Various methods are described herein, and each of the methods comprises one or more steps or actions for achieving the described method. Unless a specific order of steps or actions is required for proper operation of the method, the order and/or use of specific steps and/or actions may be modified or combined.

Various embodiments, e.g., methods, and other aspects described in this document can be used to modify a system such as the example shown in FIG. 10 that is described in detail below. For example, one or more devices, features, modules, etc. of the example of FIG. 10, and/or the arrangement of devices, features, modules, etc. of the system (e.g., architecture of the system) can be modified. Unless indicated otherwise, or technically precluded, the aspects, embodiments, etc. described in this document can be used individually or in combination.

Various numeric values are used in the present document, for example. The specific values are for example purposes and the aspects described are not limited to these specific values.

FIG. 10 illustrates a block diagram of an example of a system in which various aspects and embodiments can be implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit, multiple ICs, and/or discrete components. For example, in at least one embodiment, the processing and encoder/decoder elements of system 1000 are distributed across multiple ICs and/or discrete components. In various embodiments, the system 1000 is communicatively coupled to other similar systems, or to other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, EEPROM, ROM, PROM, RAM, DRAM, SRAM, flash, magnetic disk drive, and/or optical disk drive. The storage device 1040 can include an internal storage device, an attached storage device, and/or a network accessible storage device, as non-limiting examples.

System 1000 can include an encoder/decoder module 1030 configured, for example, to process image data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream or signal, matrices, variables, and intermediate or final results from the processing of equations, formulas, operations, and operational logic.

In several embodiments, memory inside of the processor 1010 and/or the encoder/decoder module 1030 is used to store instructions and to provide working memory for processing that is needed during operations such as those described herein. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC (Versatile Video Coding).

The input to the elements of system 1000 can be provided through various input devices as indicated in block 1130. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 1130 have associated respective input processing elements as known in the art. For example, the RF portion can be associated with elements for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010. Similarly, aspects of USB or HDMI interface processing can be implemented within separate interface ICs or within processor 1010. The demodulated, error corrected, and demultiplexed stream is provided to various processing elements, including, for example, processor 1010, and encoder/decoder 1030 operating in combination with the memory and storage elements to process the datastream for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the I2C bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed to the system 1000, in various embodiments, using a Wi-Fi network such as IEEE 802.11. The Wi-Fi signal of these embodiments is received over the communications channel 1060 and the communications interface 1050 which are adapted for Wi-Fi communications. The communications channel 1060 of these embodiments is typically connected to an access point or router that provides access to outside networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130.

The system 1000 can provide an output signal to various output devices, including a display 1100, speakers 1110, and other peripheral devices 1120. The other peripheral devices 1120 include, in various examples of embodiments, one or more of a stand-alone DVR, a disk player, a stereo system, a lighting system, and other devices that provide a function based on the output of the system 1000. In various embodiments, control signals are communicated between the system 1000 and the display 1100, speakers 1110, or other peripheral devices 1120 using signaling such as AV.Link, CEC, or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device, for example, a television. In various embodiments, the display interface 1070 includes a display driver, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various generalized as well as particularized embodiments are also supported and contemplated throughout this disclosure. Examples of embodiments in accordance with the present disclosure include but are not limited to the following.

In general, an example of at least one embodiment can involve a neural network such as a recurrent neural network (RNN) having a capability to vary its computational cost while strictly limiting the RNN computational resources.

In general, an example of at least one embodiment can involve apparatus and methods for an orchestrator/scheduler to control the computational cost of a neural network model with an upper limit clearly set out.

In general, an example of at least one embodiment can involve apparatus comprising: one or more processors configured to determine an availability of a computational resource; adapt, based on the availability, a neural network to set a limit on use of the computational resource by the neural network during processing of a sequence of data, wherein the one or more processors being configured to adapt the neural network to set the limit comprises the one or more processors being configured to modify an update control included in the neural network based on a windowing function; and process at least a portion of the sequence of data by the adapted neural network using the computational resource in accordance with the limit.

In general, an example of at least one embodiment can involve method comprising: determining an availability of a computational resource; adapting, based on the availability, a neural network to set a limit on use of the computational resource by the neural network during processing of a sequence of data, wherein adapting the neural network to set the limit comprises modifying an update control included in the neural network based on a windowing function; and processing at least a portion of the sequence of data by the adapted neural network using the computational resource in accordance with the limit.

In general, an example of at least one embodiment can involve apparatus comprising: one or more processors configured to adapt, based on an availability of a computational resource, a neural network to set a limit on use of the computational resource during processing of a sequence of data, wherein the one or more processors being configured to adapt the neural network to set the limit comprises the one or more processors being configured to modify, based on a windowing function, an update control included in the neural network; and process at least a portion of the sequence of data by the adapted neural network using the computational resource in accordance with the limit.

In general, an example of at least one embodiment can involve a method comprising: adapting, based on an availability of a computational resource, a neural network to set a limit on use of the computational resource during processing of a sequence of data, wherein adapting the neural network to set the limit comprises modifying, based on a windowing function, an update control included in the neural network; and processing at least a portion of the sequence of data by the adapted neural network using the computational resource in accordance with the limit.

In general, an example of at least one embodiment can involve apparatus comprising: one or more processors configured to implement a neural network including an update control; determine an availability of a computational resource; adapt the neural network, based on the availability, to set a limit on use of the computational resource by the neural network during processing of a sequence of data, wherein the one or more processors being configured to adapt the neural network to set the limit comprises the one or more processors being configured to modify the update control included in the neural network based on a windowing function; and process at least a portion of the sequence of data by the adapted neural network using the computational resource in accordance with the limit.

In general, an example of at least one embodiment can involve apparatus comprising: one or more processors configured to receive an indication of an availability of a computational resource; adapt, based on the indication, a neural network to set a limit on use of the computational resource during processing of a sequence of data, wherein the one or more processors being configured to adapt the neural network to set the limit comprises the one or more processors being configured to modify, based on a windowing function, an update control included in the neural network; and process at least a portion of the sequence of data by the adapted neural network using the computational resource in accordance with the limit.

In general, an example of at least one embodiment can involve a method comprising: receiving an indication of an availability of a computational resource; adapting, based on the indication, a neural network to set a limit on use of the computational resource during processing of a sequence of data, wherein adapting the neural network to set the limit comprises modifying, based on a windowing function, an update control included in the neural network; and processing at least a first portion of the sequence of data by the adapted neural network using the computational resource in accordance with the limit.

In general, an example of at least one embodiment can involve apparatus comprising: one or more processors configured to determine an availability of a computational resource; and enable, based on the availability, a modification of a neural network to set a limit on use of the computational resource by the neural network during processing of a sequence of data, wherein the modification comprises modifying, based on a windowing function, an update control included in the neural network.

In general, an example of at least one embodiment can involve a method comprising: determining an availability of a computational resource; and enabling, based on the availability, a modification of a neural network to set a limit on use of the computational resource by the neural network during processing of a sequence of data, wherein the modification comprises modifying, based on a windowing function, an update control included in the neural network.

In general, an example of at least one embodiment can involve apparatus or a method as described herein adapting or modifying an update control of a neural network based a windowing function, wherein the windowing function defines a window including a first group of inputs associated with the sequence of data, and wherein the adapting or modifying comprises defining, based on the limit, a probability of each input in the first group of inputs to be processed; and selecting, from among the first group of inputs to be processed based on the probability of each input in the first group to be processed, a second group of inputs, wherein the first group of inputs includes a greater number of inputs than the second group of inputs.

In general, an example of at least one embodiment can involve apparatus or a method as described herein adapting or modifying an update control of a neural network based on a windowing function, wherein the windowing function defines a window including a first group of inputs, and wherein adapting or modifying the neural network to set the limit on use of the computational resource comprises the one or more processors being further configured to select, based on a function associated with setting the limit, a second group of inputs to be processed, wherein the second group of inputs is selected from among the first group of inputs, and the second group of inputs includes fewer inputs than the first group of inputs.

In general, an example of at least one embodiment can involve apparatus or a method as described herein adapting or modifying an update control of a neural network based on a windowing function, wherein the windowing function defines a window including a first group of inputs, and wherein the adapting of the neural network to set the limit on use of the computational resource further comprises selecting, based on a function associated with setting the limit, a second group of inputs to be processed, wherein the second group of inputs is selected from among the first group of inputs, and the second group of inputs includes fewer inputs than the first group of inputs.

In general, an example of at least one embodiment can involve apparatus or a method as described herein involving adapting or modifying an update control of a neural network, wherein a function associated with selecting a second group of inputs comprises at least one of:
a) a Top-K function; or
b) a stochastic sampling mechanism; or
c) a selection of inputs based on a probability of each input to be processed exceeding a threshold; or
d) a random sampling of the selection of inputs in (c); or
e) a determination of a distance between the inputs included in the selection of inputs in (c); or
f) a selection of inputs and an input processing operation for each selected input based on the cost of each processing operation.

In general, an example of at least one embodiment can involve apparatus or a method as described herein involving adapting or modifying a neural network to process a sequence of data and further comprising determining a constraint associated with processing the sequence of data; modifying, based on the constraint, a parameter of a decision function included in the neural network; and processing at least a portion of the sequence of data by the adapted neural network using the computational resource in accordance with the limit and based on the constraint.

In general, an example of at least one embodiment can involve apparatus or a method as described herein involving adapting or modifying a neural network, wherein a constraint comprises at least one of a resource availability, or a resource requirement of the neural network, or an accuracy of the neural network.

In general, an example of at least one embodiment can involve apparatus or a method as described herein involving adapting or modifying a neural network, wherein the neural network includes a decision function comprising a binarization function and a parameter of the decision function comprises a threshold of the binarization function.

In general, an example of at least one embodiment can involve apparatus or a method as described herein involving adapting or modifying a neural network, wherein the neural network includes a decision function comprising a binarization function and a parameter of the decision function comprises a threshold of the binarization function, wherein the threshold of the binarization function comprises a value at which an output of the binarization function switches between 0 and 1.

In general, at least one other example of an embodiment can involve an apparatus or method including a neural network adapted by varying a parameter of a binarization function, wherein the parameter of the binarization function comprises a threshold value at which the binarization function value switches between 0 and 1.

In general, at least one other example of an embodiment can involve an apparatus or method including a neural network as described herein, wherein the neural network comprises a recurrent neural network.

In general, at least one other example of an embodiment can involve an apparatus or method including a recurrent neural network as described herein, wherein the recurrent neural network comprises a skip neural network.

In general, at least one other example of an embodiment can involve an apparatus or method can involve adapting or modifying a neural network based on receiving an indication, wherein the indication is received from an orchestrator.

In general, at least one other example of an embodiment can involve an apparatus or method including adapting a neural network, wherein the adapting occurs during training of the neural network.

In general, at least one other example of an embodiment can involve an apparatus or method including adapting a neural network during training, wherein adapting during training comprises varying a parameter for each of a plurality of minibatches of data during training.

In general, at least one other example of an embodiment can involve an apparatus or method including a neural network adapted based on providing information to an orchestrator, wherein providing the information to the orchestrator comprises providing metadata including the information to the orchestrator.

In general, at least one other example of an embodiment can involve an apparatus or method including a neural network adapted by varying a parameter of a binarization function, wherein the parameter of the binarization function comprises a threshold value at which the binarization function value switches between 0 and 1.

In general, at least one other example of an embodiment can involve an apparatus or method including a neural network adapted by varying a parameter of a selectK function, wherein the parameter of the selectK function comprises a parameter value controlling the number of inputs processed.

In general, at least one example of an embodiment can involve a computer program product including instructions, which, when executed by a computer, cause the computer to carry out any one or more of the methods described herein.

In general, at least one example of an embodiment can involve a non-transitory computer readable medium storing executable program instructions to cause a computer executing the instructions to perform any one or more of the methods described herein.

In general, at least one example of an embodiment can involve a device comprising an apparatus according to any embodiment of apparatus as described herein, and at least one of (i) an antenna configured to receive a signal, the signal including data representative of information such as instructions from an orchestrator, (ii) a band limiter configured to limit the received signal to a band of frequencies that includes the data representative of the information, and (iii) a display configured to display an image such as a displayed representation of the data representative of the instructions.

In general, at least one example of an embodiment can involve a device as described herein, wherein the device comprises one of a television, a television signal receiver, a set-top box, a gateway device, a mobile device, a cell phone, a tablet, or other electronic device.

Regarding the various embodiments described herein and the figures illustrating various embodiments, when a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, one or more of a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this document are not necessarily all referring to the same embodiment.

Additionally, this document may refer to “obtaining” various pieces of information. Obtaining the information can include one or more of, for example, determining the information, estimating the information, calculating the information, predicting the information, or retrieving the information from memory.

Further, this document may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this document may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters for refinement. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream or signal of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium. Various embodiments have been described. Embodiments may include any of the following features or entities, alone or in any combination, across various different claim categories and types:
Providing a neural network such as a recurrent neural network (RNN) having a capability to vary its computational cost while strictly limiting the RNN computational resources.
Providing apparatus and methods for an orchestrator/scheduler to control the computational cost of a neural network model with an upper limit clearly set out.
Providing apparatus comprising: one or more processors configured to determine an availability of a computational resource; adapt, based on the availability, a neural network to set a limit on use of the computational resource by the neural network during processing of a sequence of data, wherein the one or more processors being configured to adapt the neural network to set the limit comprises the one or more processors being configured to modify an update control included in the neural network based on a windowing function; and process at least a portion of the sequence of data by the adapted neural network using the computational resource in accordance with the limit.
Providing a method comprising: determining an availability of a computational resource; adapting, based on the availability, a neural network to set a limit on use of the computational resource by the neural network during processing of a sequence of data, wherein adapting the neural network to set the limit comprises modifying an update control included in the neural network based on a windowing function; and processing at least a portion of the sequence of data by the adapted neural network using the computational resource in accordance with the limit.
Providing apparatus comprising: one or more processors configured to adapt, based on an availability of a computational resource, a neural network to set a limit on use of the computational resource during processing of a sequence of data, wherein the one or more processors being configured to adapt the neural network to set the limit comprises the one or more processors being configured to modify, based on a windowing function, an update control included in the neural network; and process at least a portion of the sequence of data by the adapted neural network using the computational resource in accordance with the limit.
Providing a method comprising: adapting, based on an availability of a computational resource, a neural network to set a limit on use of the computational resource during processing of a sequence of data, wherein adapting the neural network to set the limit comprises modifying, based on a windowing function, an update control included in the neural network; and processing at least a portion of the sequence of data by the adapted neural network using the computational resource in accordance with the limit.
Providing apparatus comprising: one or more processors configured to implement a neural network including an update control; determine an availability of a computational resource; adapt the neural network, based on the availability, to set a limit on use of the computational resource by the neural network during processing of a sequence of data, wherein the one or more processors being configured to adapt the neural network to set the limit comprises the one or more processors being configured to modify the update control included in the neural network based on a windowing function; and process at least a portion of the sequence of data by the adapted neural network using the computational resource in accordance with the limit.
Providing apparatus comprising: one or more processors configured to receive an indication of an availability of a computational resource; adapt, based on the indication, a neural network to set a limit on use of the computational resource during processing of a sequence of data, wherein the one or more processors being configured to adapt the neural network to set the limit comprises the one or more processors being configured to modify, based on a windowing function, an update control included in the neural network; and process at least a portion of the sequence of data by the adapted neural network using the computational resource in accordance with the limit.
Providing a method comprising: receiving an indication of an availability of a computational resource; adapting, based on the indication, a neural network to set a limit on use of the computational resource during processing of a sequence of data, wherein adapting the neural network to set the limit comprises modifying, based on a windowing function, an update control included in the neural network; and processing at least a first portion of the sequence of data by the adapted neural network using the computational resource in accordance with the limit.
Providing apparatus comprising: one or more processors configured to determine an availability of a computational resource; and enable, based on the availability, a modification of a neural network to set a limit on use of the computational resource by the neural network during processing of a sequence of data, wherein the modification comprises modifying, based on a windowing function, an update control included in the neural network.
Providing a method comprising: determining an availability of a computational resource; and enabling, based on the availability, a modification of a neural network to set a limit on use of the computational resource by the neural network during processing of a sequence of data, wherein the modification comprises modifying, based on a windowing function, an update control included in the neural network.
Providing apparatus or a method as described herein adapting or modifying an update control of a neural network based a windowing function, wherein the windowing function defines a window including a first group of inputs associated with the sequence of data, and wherein the adapting or modifying comprises defining, based on the limit, a probability of each input in the first group of inputs to be processed; and selecting, from among the first group of inputs to be processed based on the probability of each input in the first group to be processed, a second group of inputs, wherein the first group of inputs includes a greater number of inputs than the second group of inputs.
Providing apparatus or a method as described herein adapting or modifying an update control of a neural network based on a windowing function, wherein the windowing function defines a window including a first group of inputs, and wherein adapting or modifying the neural network to set the limit on use of the computational resource comprises the one or more processors being further configured to select, based on a function associated with setting the limit, a second group of inputs to be processed, wherein the second group of inputs is selected from among the first group of inputs, and the second group of inputs includes fewer inputs than the first group of inputs.
Providing apparatus or a method as described herein adapting or modifying an update control of a neural network based on a windowing function, wherein the windowing function defines a window including a first group of inputs, and wherein the adapting of the neural network to set the limit on use of the computational resource further comprises selecting, based on a function associated with setting the limit, a second group of inputs to be processed, wherein the second group of inputs is selected from among the first group of inputs, and the second group of inputs includes fewer inputs than the first group of inputs.
Providing apparatus or a method as described herein involving adapting or modifying an update control of a neural network, wherein a function associated with selecting a second group of inputs comprises at least one of:
   a) a Top-K function; or
   b) a stochastic sampling mechanism; or
   c) a selection of inputs based on a probability of each input to be processed exceeding a threshold; or
   d) a random sampling of the selection of inputs in (c); or
   e) a determination of a distance between the inputs included in the selection of inputs in (c); or
   f) a selection of inputs and an input processing operation for each selected input based on the cost of each processing operation.
Providing apparatus or a method as described herein involving adapting or modifying a neural network to process a sequence of data and further comprising determining a constraint associated with processing the sequence of data; modifying, based on the constraint, a parameter of a decision function included in the neural network; and processing at least a portion of the sequence of data by the adapted neural network using the computational resource in accordance with the limit and based on the constraint.
Providing apparatus or a method as described herein involving adapting or modifying a neural network, wherein a constraint comprises at least one of a resource availability, or a resource requirement of the neural network, or an accuracy of the neural network.
Providing apparatus or a method as described herein involving adapting or modifying a neural network, wherein the neural network includes a decision function comprising a binarization function and a parameter of the decision function comprises a threshold of the binarization function.
Providing apparatus or a method as described herein involving adapting or modifying a neural network, wherein the neural network includes a decision function comprising a binarization function and a parameter of the decision function comprises a threshold of the binarization function, wherein the threshold of the binarization function comprises a value at which an output of the binarization function switches between 0 and 1.
Providing an apparatus or method including a neural network adapted by varying a parameter of a binarization function, wherein the parameter of the binarization function comprises a threshold value at which the binarization function value switches between 0 and 1.
Providing an apparatus or method including a neural network adapted by varying a parameter of a selectK function, wherein the parameter of the selectK function comprises a parameter value controlling the number of inputs processed.
Providing an apparatus or method including a neural network as described herein, wherein the neural network comprises a recurrent neural network.
Providing an apparatus or method including a recurrent neural network as described herein, wherein the recurrent neural network comprises a skip neural network.
Providing an apparatus or method involving adapting or modifying a neural network based on receiving an indication, wherein the indication is received from an orchestrator. Providing an apparatus or method including adapting a neural network, wherein the adapting occurs during training of the neural network.
Providing an apparatus or method including adapting a neural network during training, wherein adapting during training comprises varying a parameter for each of a plurality of minibatches of data during training.
Providing an apparatus or method including a neural network adapted based on providing information to an orchestrator, wherein providing the information to the orchestrator comprises providing metadata including the information to the orchestrator.
Providing an apparatus or method including a neural network adapted based on providing information to an orchestrator, wherein providing the information to the orchestrator comprises providing metadata including the information to the orchestrator;
Providing an apparatus or method including a neural network adapted by varying one or more parameters of a decision function, wherein the one or more parameters comprise a binarization function and the binarization function comprises a threshold value at which the binarization function value switches between 0 and 1.
Providing a computer program product including instructions, which, when executed by a computer, cause the computer to carry out any one or more of the methods described herein.
Providing a non-transitory computer readable medium storing executable program instructions to cause a computer executing the instructions to perform any one or more of the methods described herein.
Providing a device comprising an apparatus according to any embodiment of apparatus as described herein, and at least one of (i) an antenna configured to receive a signal, the signal including data representative of information such as instructions from an orchestrator, (ii) a band limiter configured to limit the received signal to a band of frequencies that includes the data representative of the information, and (iii) a display configured to display an image such as a displayed representation of the data representative of the instructions.
Providing a device as described herein, wherein the device comprises one of a television, a television signal receiver, a set-top box, a gateway device, a mobile device, a cell phone, a tablet, a server or other electronic device.

Various other generalized, as well as particularized embodiments are also supported and contemplated throughout this disclosure.

1-28. (canceled)

29. A device comprising:
a transceiver; and
a processor configured to:
send, via the transceiver, a model identifier identifying a model and an indication of a first resource constraint associated with the device;
receive, via the transceiver, a first model configuration of the identified model, wherein the first model configuration is configured to operate within the first resource constraint associated with the device;
process first data using the first model configuration;
based on processing the first data, send, via the transceiver, a request for a model update and an indication of the second resource constraint associated with the device;
receive, via the transceiver, a second model configuration, wherein the second model configuration is configured to operate within the second resource constraint associated with the device; and
process second data using the second model configuration.

30. The device of claim 29, wherein the device comprises a smartphone.

31. The device of claim 29, wherein the second model configuration comprises a complete second model.

32. The device of claim 29, wherein the second model configuration comprises at least one parameter update to the first model configuration.

33. The device of claim 29, wherein the second model configuration is configured to operate within the first resource constraint and within the second resource constraint.

34. The device of claim 29, wherein at least one of the first resource constraint or the second resource constraint comprises at least one of a limit on computational resources associated with the device, or an accuracy constraint.

35. The device of claim 29, wherein at least one of the first resource constraint or the second resource constraint comprises a resource availability constraint.

36. The device of claim 29, wherein the determined second resource constraint is based on the device moving to an edge computing node close to the device.

37. The device of claim 29, wherein at least one of the first model configuration or the second model configuration is configured to process at least one of the first data or the second data based on a windowing function.

38. The device of claim 29, wherein the first model configuration and the second model configuration comprise a neural network.

39. A method comprising:
sending a model identifier identifying a model and an indication of a first resource constraint associated with a device;
receiving a first model configuration of the identified model, wherein the first model configuration is configured to operate within the first resource constraint associated with the device;
processing first data using the first model configuration;
based on processing the first data, sending a request for a model update and an indication of the second resource constraint associated with the device;
receiving a second model configuration, wherein the second model configuration is configured to operate within the second resource constraint associated with the device; and
processing second data using the second model configuration.

40. The method of claim 39, wherein the device comprises a smartphone.

41. The method of claim 39, wherein the second model configuration comprises a complete second model.

42. The method of claim 39, wherein the second model configuration comprises at least one parameter update to the first model configuration.

43. The method of claim 39, wherein the second model configuration is configured to operate within the first resource constraint and within the second resource constraint.

44. The method of claim 39, wherein at least one of the first resource constraint or the second resource constraint comprises at least one of a resource availability constraint, a limit on computational resources associated with the device, or an accuracy constraint.

45. The method of claim 39, wherein the determined second resource constraint is based on the device moving to an edge computing node close to the device.

46. The method of claim 39, wherein at least one of the first model configuration or the second model configuration is configured to process at least one of the first data or the second data based on a windowing function.

47. The method of claim 39, wherein the first model configuration and the second model configuration comprise a neural network.

48. At least one computer-readable storage medium having executable instructions stored thereon, that when executed by a processor cause the processor to:
send a model identifier identifying a model and an indication of a first resource constraint associated with a device;
receive a first model configuration of the identified model, wherein the first model configuration is configured to operate within the first resource constraint associated with the device;
process first data using the first model configuration;
based on processing the first data, send, via the transceiver, a request for a model update and an indication of the second resource constraint associated with the device;
receive a second model configuration, wherein the second model configuration is configured to operate within the second resource constraint associated with the device; and
process second data using the second model configuration.
